(19) United States
(12) Patent Application Publication
(10) Pub. No.: US 2025/0385814 A1
(43) Pub. Date: Dec. 18, 2025

(54) PORT REDUCTION WITH REDUCED DIMENSION IN ANTENNA DOMAIN

(71) Applicant: Samsung Electronics Co., Ltd., Suwon-si (KR)

(72) Inventors: Kyeong Jin Kim, Plano, TX (US); Yeqing Hu, Allen, TX (US); Yang Li, Plano, TX (US); Jianzhong Zhang, Plano, TX (US)

(21) Appl. No.: 19/064,569

(22) Filed: Feb. 26, 2025

Related U.S. Application Data
(60) Provisional application No. 63/660,985, filed on Jun. 17, 2024.

(51) Int. Cl. H04L 25/02; H01Q 1/24

(52) U.S. Cl. CPC H04L 25/0224; H01Q 1/246

(57) ABSTRACT

An embodiment includes applying port reduction to two CFR inputs and a channel estimate is applied to the received CFR with the reduced dimension in the antenna domain, in particular, the channel estimator uses the outputs from a port reduction block whose antenna dimension is reduced by the port reduction algorithm, such as canonical model (CM)-based port reduction or a maximum-ratio combining (MRC)-based port reduction, and the channel estimator may use least squares estimators to apply the channel estimation in the reduced dimension in the antenna domain.

### CROSS-REFERENCE TO RELATED APPLICATION(S)

This application claims the benefit of priority from U.S. Provisional Application No. 63/660,985, entitled “JOINT CHANNEL ESTIMATION AND PORT REDUCTION IN 7-3 ORAN SPLIT” filed Jun. 17, 2024, which is incorporated herein by reference in its entirety.

### TECHNICAL FIELD

This disclosure relates generally to a wireless communication system, and more particularly to, for example, but not limited to, joint channel estimation and port reduction in wireless networks.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

The description set forth in the background section should not be assumed to be prior art merely because it is set forth in the background section. The background section may describe aspects or embodiments of the present disclosure.

### SUMMARY

One aspect of the present disclosure provides a base station (BS) in a wireless communication system, comprising a memory; and a processor coupled to the memory. The processor is configured to receive a demodulation reference signal (DMRS) symbol that includes channel frequency response information. The processor is configured to perform port reduction to the channel frequency response information so as to reduce a dimension in an antenna domain for the channel frequency response information. The processor is configured to perform channel estimation on the channel frequency response information with the reduced dimension in the antenna domain.

In some embodiments, the port reduction is performed to the channel frequency response information based on a total number of antenna ports and a target number of antenna ports in the antenna domain, the target number of antenna ports being smaller than the total number of antenna ports.

In some embodiments, the channel frequency response information is associated with at least one of a particular DMRS subcarrier, a particular physical uplink channel symbol, or a particular element of an antenna array.

In some embodiments, the channel frequency response information is associated with the DMRS symbol and a channel response of the DMRS symbol.

In some embodiments, the port reduction is performed using a maximum ratio combining for the DMRS symbol; and the processor is configured to compute a channel response at a particular DMRS subcarrier, a particular physical uplink channel symbol, and a particular element of an antenna array

In some embodiments, the port reduction is performed using a maximum ratio combining for a plurality of DMRS symbols that are time independent and frequency dependent.

In some embodiments, the port reduction is performed using a canonical model for one DMRS symbol that includes a canonical-based port reduction matrix, the canonical-based port reduction matrix being obtained based on the channel frequency response information.

In some embodiments, the port reduction is performed using a canonical model for a plurality of DMRS symbols, wherein the channel frequency information is based on a port reduction matrix and a DMRS subcarrier.

In some embodiments, the channel estimation is performed using a least-squares based channel estimation based on a reduced number of ports.

In some embodiments, the processor is further configured to: perform frequency domain interpolation to the estimated channel to generate revised channel estimates; and perform time domain interpolation to the revised channel estimates.

One aspect of the present disclosure provides a computer-implemented method for wireless communication by a base station (BS). The method comprises receiving a demodulation reference signal (DMRS) symbol that includes channel frequency response information. The method comprises performing port reduction to the channel frequency response information so as to reduce a dimension in an antenna domain for the channel frequency response information. The method comprises performing channel estimation on the channel frequency response information with the reduced dimension in the antenna domain.

In some embodiments, the port reduction is performed to the channel frequency response information based on a total number of antenna ports and a target number of antenna ports in the antenna domain, the target number of antenna ports being smaller than the total number of antenna ports.

In some embodiments, the channel frequency response information is associated with at least one of a particular DMRS subcarrier, a particular physical uplink channel symbol, or a particular element of an antenna array.

In some embodiments, the channel frequency response information is associated with the DMRS symbol and a channel response of the DMRS symbol.

In some embodiments, the port reduction is performed using a maximum ratio combining for the DMRS symbol; and the method further comprises computing a channel response at a particular DMRS subcarrier, a particular physical uplink channel symbol, and a particular element of an antenna array

In some embodiments, the port reduction is performed using a maximum ratio combining for a plurality of DMRS symbols that are time independent and frequency dependent.

In some embodiments, the port reduction is performed using a canonical model for one DMRS symbol that includes a canonical-based port reduction matrix, the canonical-based port reduction matrix being obtained based on the channel frequency response information.

In some embodiments, the port reduction is performed using a canonical model for a plurality of DMRS symbols, wherein the channel frequency information is based on a port reduction matrix and a DMRS subcarrier.

In some embodiments, the channel estimation is performed using a least-squares based channel estimation based on a reduced number of ports.

In some embodiments, the method further comprises performing frequency domain interpolation to the estimated channel to generate revised channel estimates; and performing time domain interpolation to the revised channel estimates.

### BRIEF DESCRIPTION OF THE DRAWINGS

FIG. 1 shows an example of a wireless network in accordance with an embodiment.

FIGS. 2A and 2B illustrate example wireless transmit and receive paths in accordance with an embodiment.

FIG. 3A illustrates an example user equipment (UE) in accordance with an embodiment.

FIG. 3B illustrates an example gNB in accordance with an embodiment.

FIG. 4 illustrates a beamforming architecture in accordance with an embodiment.

FIG. 5 illustrates an example receiver structure under 7-3 split in accordance with an embodiment.

FIG. 6 illustrates an antenna array configuration at the front-head of an massive multiple input multiple output unit (MMU) in accordance with an embodiment.

FIG. 7 illustrates a preprocessing part of the channel estimation that accomplishes port reduction in accordance with an embodiment.

FIG. 8A illustrates preprocessing for channel estimation using maximum-ratio combining (MRC)-based port reduction in accordance with an embodiment.

FIG. 8B illustrates preprocessing for channel estimation using canonical mode (CM)-based port reduction in accordance with an embodiment.

FIG. 9 illustrates an example of codebook (CB) generation in terms of the configuration of the antenna array in accordance with an embodiment.

FIG. 10 illustrates sampling angular and selected grids to generate beams (basis) in accordance with an embodiment.

FIG. 11 illustrates a main channel estimation flow that processes the outputs of the port reduction in accordance with an embodiment.

FIG. 12 illustrates a flow chart of an example process for a BA session transfer in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

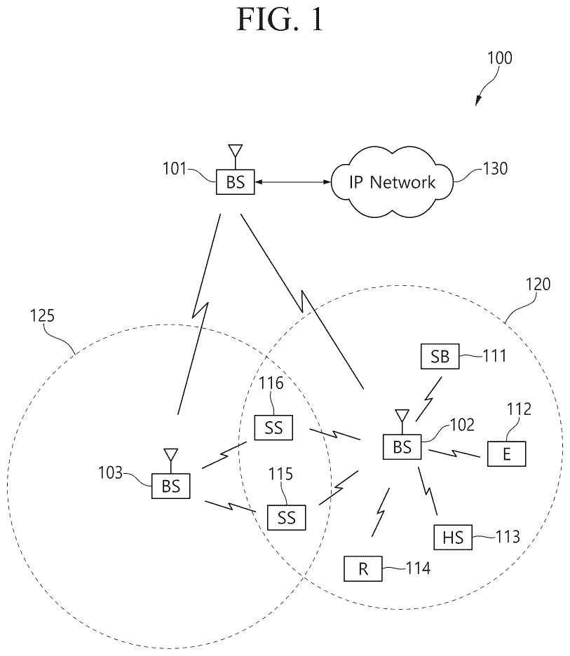

FIG. 1 illustrates an example wireless network 100 according to this disclosure. The embodiment of the wireless network 100 shown in FIG. 1 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an gNB, whether the UE is a mobile device (such as a mobile telephone or smartphone) or is normally considered a stationary device (such as a desktop computer or vending machine).

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

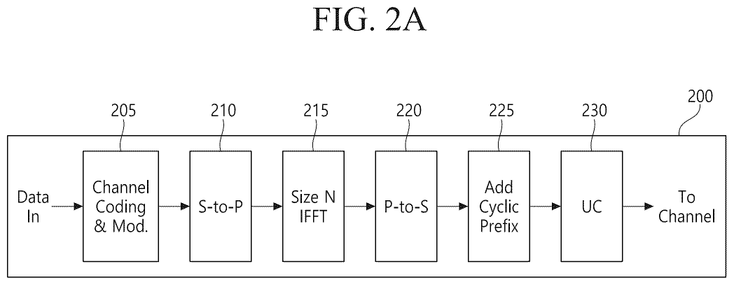

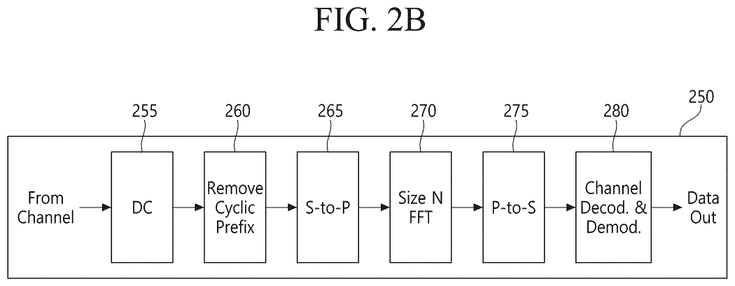

FIGS. 2A and 2B illustrate example wireless transmit and receive paths according to this disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

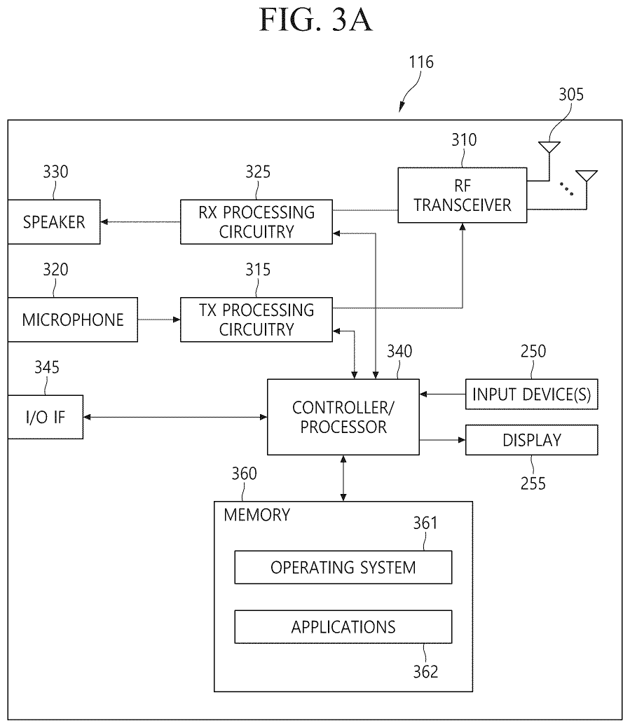

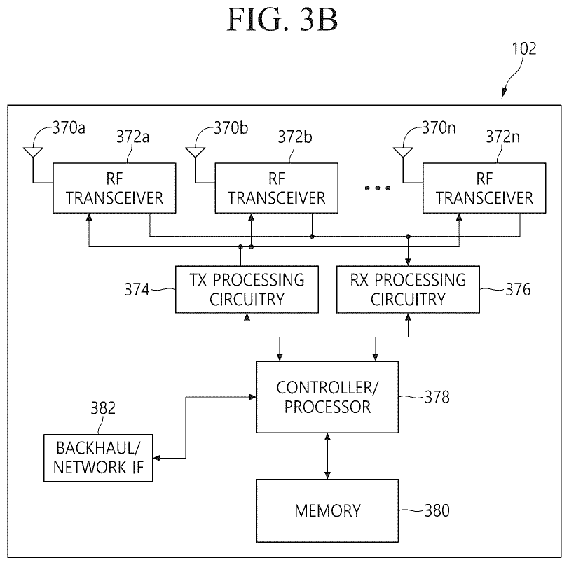

FIG. 3A illustrates an example UE 116 according to this disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the present disclosure as described in embodiments of the present disclosure. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to this disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of an gNB 102, various changes may be made to FIG. 3B. For example, the gNB 102 can include any number of each component shown in FIG. 3. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Rel.13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports remain more or less the same.

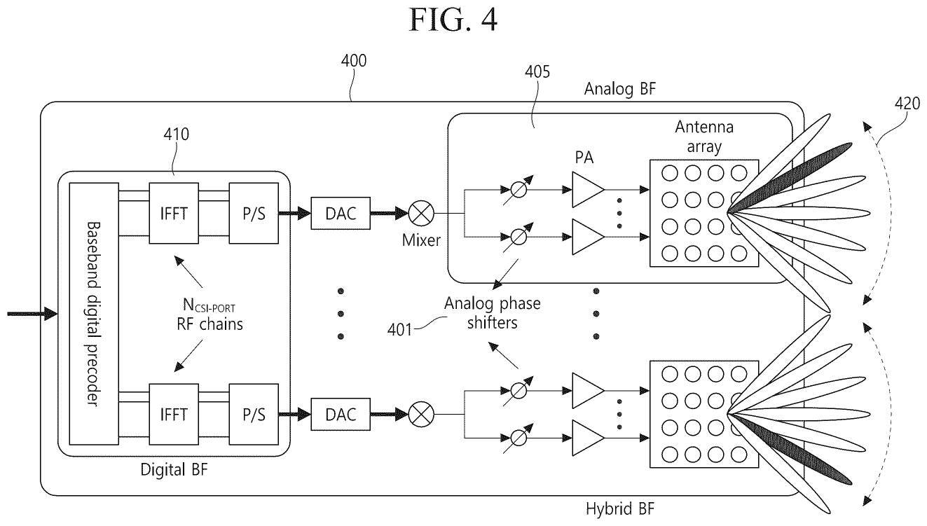

For mm Wave bands, although the number of antenna elements can be larger for a given form factor, the number of CSI-RS ports, which can correspond to the number of digitally precoded ports, tends to be limited due to hardware constraints (such as the feasibility to install a large number of ADCs/DACs at mmWave frequencies) as illustrated by beamforming architecture 400 in FIG. 4 in accordance with an embodiment.

FIG. 4 illustrates a beamforming architecture in accordance with an embodiment. As illustrated, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports NCSI-PORT. A digital beamforming unit 410 performs a linear combination across NCSI-PORT analog beams to further increase precoding gain. While analog beams are wideband (hence not frequency-selective), digital precoding can be varied across frequency sub-bands or resource blocks.

The text and figures are provided solely as examples to aid the reader in understanding the disclosed technology. They are not intended and are not to be construed as limiting the scope of the disclosed technology in any manner. Although certain embodiments and examples have been provided, it will be apparent to those skilled in the art based on the disclosures herein that changes in the embodiments and examples shown may be made without departing from the scope of the disclosed technology.

In 5G networks, a gNB is typically equipped with tens of transceivers (TXRUs). The large number of TXRU enhances network performance, while also put high requirement for the gNB processing capability, such as precoding weight calculation for DL transmission, or equalization in UL data reception.

Embodiments in accordance with this disclosure may reduce the computation complexity by performing port reduction, so that the channel estimation and equalization operates on a smaller data dimension compared to the Rx antenna number. The manner in which the number of ports or data dimension are reduced may be a design trade-off between complexity and performance.

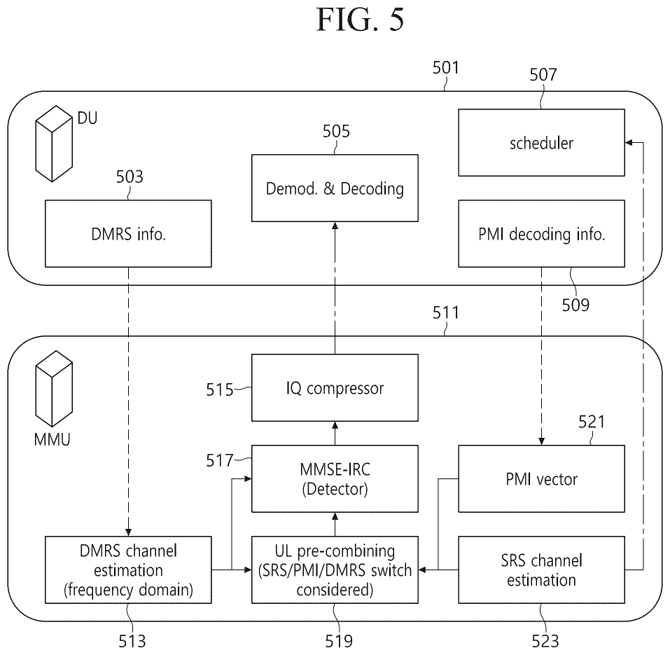

FIG. 5 illustrates an example receiver structure in accordance with an embodiment. In some embodiments, the receiver may be an Open Radio Access Network (O-RAN) 7-3 split structure that provides a function split that places physical layer (PHY) processing in a digital unit (DU). In particular, FIG. 5 illustrates a digital unit (DU) (501) that includes a Demodulation Reference Signal (DMRS) info module 503, a Demodulating & Decoding module 505, a scheduler module 507, and a precoding matrix indicator (PMI) decoding info module 509. FIG. 5 also illustrates a massive MIMO unit 511, that includes a DMRS channel estimation (frequency domain) module 513, a IQ compressor module 515, a Minimum Mean Square Error Interference Rejection Combiner (MMSE-IRC) (detector) module 517, a UL pre-combining (SRS/PMI/DMRS switch considered) module 519, a PMI vector module 521, and a SRS channel estimation module 523.

The Demodulation Reference Signal (DMRS) information is passed from digital unit (DU) 501 to massive MIMO unit (MMU) 511. Inside the MMU, channel may be estimated according to the DMRS using DMRS channel estimation (frequency domain) module 513. The received data is then pre-combined or dimension-reduced, with UL pre-combining (SRS/PMI/DMRS switch considered) module 519, using Precoding Matrix Indictor (PMI), Sound Reference Signal (SRS), DMRS, or common beam information. The reception data is then equalized and demodulated, using Demodulation and Decoding module 505. The UL pre-combing module 519 may also receive PMI vector data from PMI vector module and SRS channel estimation data from SRS channel estimation module 523. The SRS channel estimation module 523 may provide data to schedule 507. The PMI vector module 521 may receive PM decoding information from the PMI decoding info module 509.

When compressing the data dimension, it may be desirable to preserve or improve the performance of full-port reception. With existing methods, common beam based combining often suffers from loss due to inadaptable combining weight; SRS-based Maximum-Ratio combining (MRC) is not for low SNR or high interference or high mobility; PMI based combining is complement to SRS-based combining; and DMRS-based port reduction may be considered to help channel aging issues but not low signal to interference and noise ratio (SINR).

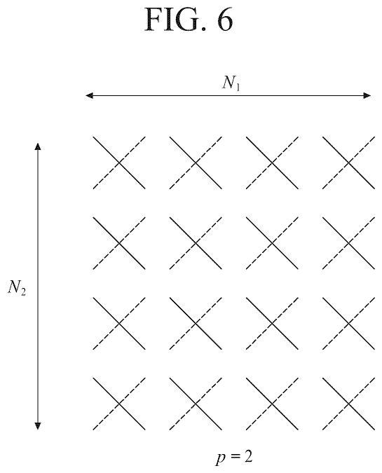

FIG. 6 illustrates an antenna array configuration at the front-head of an MMU in accordance with an embodiment. As illustrated, the antenna array configuration includes N₂ rows and N₁ columns, with p=2.

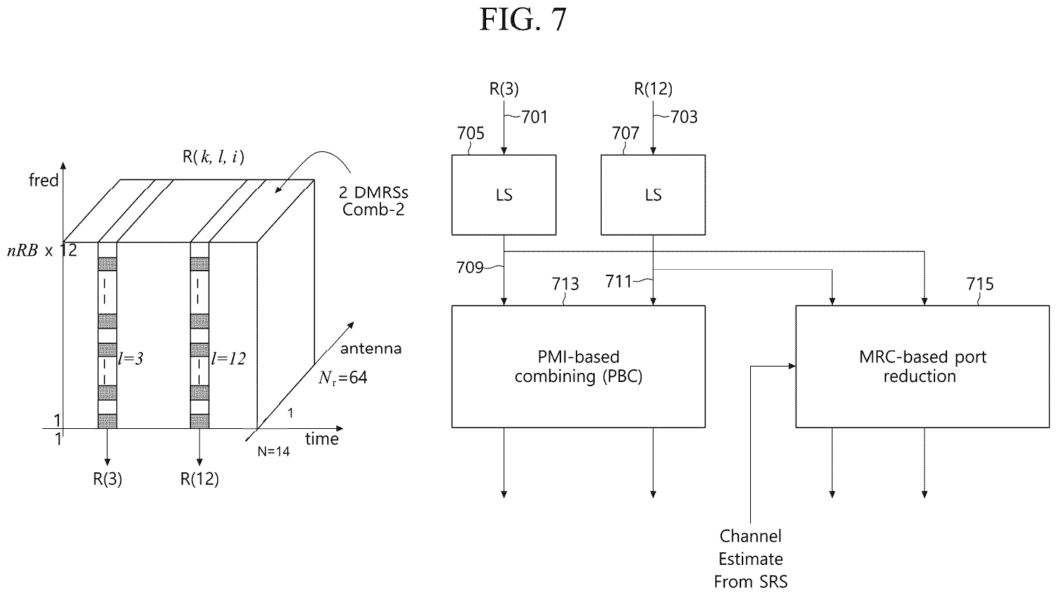

FIG. 7 illustrates existing techniques for a preprocessing part of channel estimation that accomplishes port reduction in accordance with an embodiment. In particular, FIG. 7 illustrates DMRS-based MRC 715 that uses SRS channel estimate 717 or a PMI-based combining (PBC) 713 that uses input PMI. As illustrated in FIG. 7, for two the channel frequency response (CFR) at the scattered DMRS pilot subcarriers, 701 and 703, a channel estimation, using least squares (LS) 705 and 707 is applied. For the channel estimator outputs, 709 and 711, a port reduction may occur by the PMI-based combining (PBC) 713 or the Maximum-Ratio combining (MRC)-based port reduction 715.

In contrast to existing techniques, embodiments in accordance with this disclosure may apply a port reduction to CFR inputs, whereby the port reduction block may work without additional channel information and channel estimates.

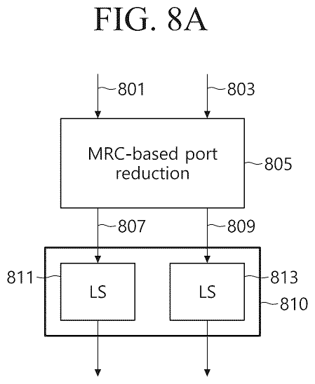

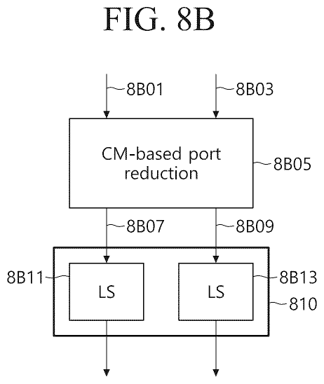

FIG. 8A illustrates preprocessing for channel estimation using an MRC-based port reduction in accordance with an embodiment. In particular, two CFR inputs, 801 and 803 are provided to the MRC-based port reduction 805 to generate outputs 807 and 809 whose antenna dimension is reduced by an MRC-based port reduction algorithm. The outputs 807 and 809 of the MRC-based port reduction block 805 are provided to channel estimator block 810, which includes two LS estimators 811 and 813 that apply the channel estimation in a reduced dimension in the antenna domain.

FIG. 8B illustrates preprocessing for channel estimation using a CM-based port reduction in accordance with an embodiment. In particular, two CFR inputs, 8B01 and 8B03 are provided to the CM-based port reduction 8B05 to generate outputs 8B07 and 8B09 whose antenna dimension is reduced by a CM-based port reduction algorithm. The outputs 8B07 and 8B09 of the CM-based port reduction block 8B05 are provided to channel estimator block 810, which includes two LS estimators 8B11 and 8B13 that apply the channel estimation in a reduced dimension in the antenna domain.

Received DMRS-related channel frequency response in accordance with this disclosure is described herein. In some embodiments, the DMRS signals that occupy the same bandwidth as the data transmission data are time multiplexed with the data transmission. Depending on DMRS configuration and type, the channel frequency response (CFR) at the kth DMRS pilot subcarrier, lth Physical Uplink Shared Channel (PUSCH) symbol, and rth element of gNB antenna array is given by equation (100):

$$R ( l , k , r ) = H ( l , k , r ) P ( l , k ) + Z ( l , k , r ) , \qquad ( 100 )$$

where P(l, k) denotes the transmitted DMRS pilot at l∈{l₁, . . . , l_{d}}, k∈{k₁, k₂, . . . k_{M}_{_{SC}}}, and r={1, . . . , Nᵣ=N₁×N₂×p}. H(l,k, r) and Z(l, k, r) are corresponding channel and noise expressions. The total number of DMRS pilots is given by MS.

A decorrelation may be applied to equation (100) with the use of the conjugated DMRS pilots as provided by the following equation (101):

$$\begin{matrix}{R}_{decor} ( l , k , r ) = H ( l , k , r ) + {Z}_{1} ( l , k , r ) , \\ where {Z}_{1} ( l , k , r ) = {P}^{*} ( l , k ) Z ( l , k , r ) .\end{matrix} \qquad ( 101 )$$

For a set of r and k and at a particular DMRS symbol, i.e., l=l_{d}, the corresponding expression for equation (101) is given by equation (102):

$${R}_{decor} ( {l}_{d} ) = H ( {l}_{d} ) + {Z}_{1} ( {l}_{d} ) , \qquad ( 102 )$$

$$where$$

$${R}_{decor} ( {l}_{d} ) = [ \begin{matrix}{R}_{decor} ( {l}_{d} , {k}_{1} , 1 ) & {R}_{decor} ( {l}_{d} , {k}_{1} , 2 ) & … & {R}_{decor} ( {l}_{d} , {k}_{1} , {N}_{r} ) \\ {R}_{decor} ( {l}_{d} , {k}_{2} , 1 ) & {R}_{decor} ( {l}_{d} , {k}_{2} , 2 ) & … & {R}_{decor} ( {l}_{d} , {k}_{2} , {N}_{r} ) \\ ⋮ & ⋮ & ⋱ & ⋮ \\ {R}_{decor} ( {l}_{d} , {k}_{{M}_{SC}} , 1 ) & {R}_{decor} ( {l}_{d} , {k}_{{M}_{SC}} , 2 ) & … & {R}_{decor} ( {l}_{d} , {k}_{{M}_{SC}} , {N}_{r} )\end{matrix} ] ,$$

$$H ( {l}_{d} ) = [ \begin{matrix}H ( {l}_{d} , {k}_{1} , 1 ) & H ( {l}_{d} , {k}_{1} , 2 ) & … & H ( {l}_{d} , {k}_{1} , {N}_{r} ) \\ H ( {l}_{d} , {k}_{2} , 1 ) & H ( {l}_{d} , {k}_{2} , 2 ) & … & H ( {l}_{d} , {k}_{2} , {N}_{r} ) \\ ⋮ & ⋮ & ⋱ & ⋮ \\ H ( {l}_{d} , {k}_{{M}_{SC}} , 1 ) & H ( {l}_{d} , {k}_{{M}_{SC}} , 2 ) & … & H ( {l}_{d} , {k}_{{M}_{SC}} , {N}_{r} )\end{matrix} ] , and$$

$${Z}_{1} ( {l}_{d} ) = [ \begin{matrix}{N}_{1} ( {l}_{d} , {k}_{1} , 1 ) & {N}_{1} ( {l}_{d} , {k}_{1} , 2 ) & … & {N}_{1} ( {l}_{d} , {k}_{1} , {N}_{r} ) \\ {N}_{1} ( {l}_{d} , {k}_{2} , 1 ) & {N}_{1} ( {l}_{d} , {k}_{2} , 2 ) & … & {N}_{1} ( {l}_{d} , {k}_{2} , {N}_{r} ) \\ ⋮ & ⋮ & ⋱ & ⋮ \\ {N}_{1} ( {l}_{d} , {k}_{{M}_{SC}} , 1 ) & {N}_{1} ( {l}_{d} , {k}_{{M}_{SC}} , 2 ) & … & {N}_{1} ( {l}_{d} , {k}_{{M}_{SC}} , {N}_{r} )\end{matrix} ] .$$

As one exemplary, for l_{d}=3, equation (102) is given by R_{decor}(3)=H (3)+Z₁(3). As for an another exemplary, for l_{d}={3,12}, equation (102) is given by equation (103):

$${R}_{decor} ( [ 3 , 12 ] ) ≡ [ \text{} \begin{matrix}{R}_{decor} ( 3 ) \\ {R}_{decor} ( 12 )\end{matrix} ] = [ \begin{matrix}H ( 3 ) \\ H ( 12 )\end{matrix} ] + [ \begin{matrix}{N}_{1} ( 3 ) \\ {N}_{1} ( 12 )\end{matrix} ] = H ( [ 3 , 12 ] ) + {Z}_{1} ( [ 3 , 12 ] ) . \qquad ( 103 )$$

When k₂−k₁=2, that is comb-2 over DMRS pilot subcarriers, the dimensionality of R_{decor,[3,12]} and H_{[3,12]} is MS×Nᵣ.

Similarly, without decorrelation, the following equation (104) may be provided:

$$R ( {l}_{d} ) = H ( {l}_{d} ) ⊗ P ( {l}_{d} ) + N ( {l}_{d} ) , \qquad ( 104 )$$

where ⊗ denotes the Hadamard product or element-wised product, and P(l_{d}) is given by:

$$P ( {l}_{d} ) = [ \begin{matrix}P ( {l}_{d} , {k}_{1} ) \times ones ( 1 , {N}_{r} ) \\ P ( {l}_{d} , {k}_{2} ) \times ones ( 1 , {N}_{r} ) \\ ⋮ \\ P ( {l}_{d} , {k}_{MS} ) \times ones ( 1 , {N}_{r} )\end{matrix} ] ,$$

with ones (1, Nᵣ) denoting an 1-by-Nᵣ matrix of ones.

Thus, the raw CFR related with the first DMRS symbol can be obtained as provided by equation (105):

$$R ( 3 ) ≡ R ( {l}_{d} = 3 ) = H ( 3 ) ⊗ P ( 3 ) + Z ( 3 ) , \qquad ( 105 )$$

and the raw CFR related with two DMRS symbols as provided by equation (106):

$$R ( [ 3 , 12 ] ) ≡ [ \begin{matrix}R ( 3 ) \\ R ( 12 )\end{matrix} ] = [ \begin{matrix}H ( 3 ) \\ H ( 12 )\end{matrix} ] ⊗ [ \begin{matrix}P ( 3 ) \\ P ( 12 )\end{matrix} ] + [ \begin{matrix}N ( 3 ) \\ N ( 12 )\end{matrix} ] = H ( [ 3 , 12 ] ) ⊗ P ( [ 3 , 12 ] ) + Z ( [ 3 , 12 ] ) . \qquad ( 106 )$$

When k₂−k₁=2, that is comb-2 over DMRS pilot subcarriers, the dimensionality of R([3,12]) and P([3,12]) is 2M_{SC}×Nᵣ.

Port reduction to the raw Channel Frequency Response (CFR) in accordance with this disclosure is described herein. In some embodiments that use two DMRSs related CFR, the equation (106) may be considered in such a way as provided by equation (107):

$$C . {R ( [ 3 , 12 ] )}^{H} = C . {H ( [ 3 , 12 ] )}^{H} ⊗ {\tilde{P} ( [ 3 , 12 ] )}^{H} + C . {Z ( [ 3 , 12 ] )}^{H} , \qquad ( 107 )$$

where the compression weight or port reduction matrix C of dimension [P×Nᵣ] with P being the target number of ports to be reduced. Due to the port reduction, \tilde{P}([3,12]) should be reformulated from P([3,12]), in such a way that each of element is given by:

$$\tilde{P} ( {l}_{d} ) = [ \begin{matrix}P ( {l}_{d} , {k}_{1} ) \times ones ( 1 , P ) \\ P ( {l}_{d} , {k}_{2} ) \times ones ( 1 , P ) \\ ⋮ \\ P ( {l}_{d} , {k}_{{M}_{SC}} ) \times ones ( 1 , P )\end{matrix} ] .$$

In some embodiments that use only one DMRS symbol related CFR, equation (105) may be considered that uses only one DMRS related CFR, as provided by equation (108):

$$C . {R ( 3 )}^{H} = C . {H ( 3 )}^{H} ⊗ {\tilde{P} ( 3 )}^{H} + C . {Z ( 3 )}^{H} . \qquad ( 108 )$$

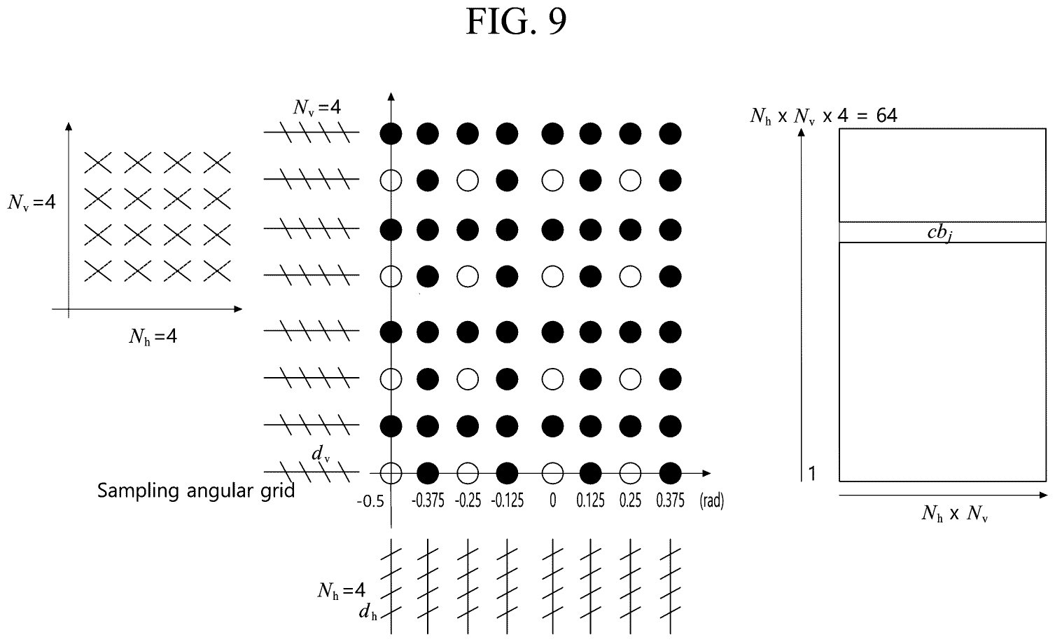

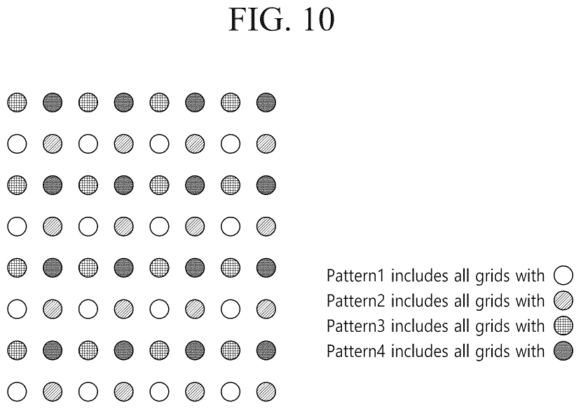

From equations (107) and (108), the first dimension of the CFR after having applied the port reduction becomes P<Nᵣ. Also, in some embodiments, the port reduction is applied to raw CFR rather than the decorrelated CFR such as R_{decor}(3) and R_{decor}([3,12]). This operation is performed in FIGS. 8A and 8B and one example of port reduction matrix C is computed from FIG. 9 and FIG. 10.

Embodiments in accordance with this disclosure may apply the port reduction without knowledge of channel estimation or decorrelated channel information. After then, channel estimation may be applied under a reduced dimension in the antenna domain.

Port reduction to the decorrelated channel frequency response (CFR) in accordance with this disclosure is described herein.

In some embodiments that use two decorrelated DMRS related CFR for the port reduction, equation (103) may be considered in such a way as provided by equation (109):

$$C . {{R}_{decor} ( [ 3 , 12 ] )}^{H} = C . {H ( [ 3 , 12 ] )}^{H} + C . {{Z}_{1} ( [ 3 , 12 ] )}^{H} . \qquad ( 109 )$$

In some embodiments that use only one, the first decorrelated, DMRS related CFR for the port reduction, equation (105) may be considered as provided by equation (110):

$$C . {{R}_{decor} ( 3 )}^{H} = C . {H ( 3 )}^{H} + C . {{Z}_{1} ( 3 )}^{H} . \qquad ( 110 )$$

Some embodiments may apply the least squares (LS)-based channel estimator first to the raw CFR and then apply the port reduction, as provided by equation (111):

$${R}_{LS} ( l , k , r ) ≡ R ( l , k , r ) / P ( l , k ) = H ( l , k , r ) + {Z}_{2} ( l , k , r ) , \qquad ( 111 )$$

where Z₂(l,k, r)≡Z (l,k, r)/P (l,k). Due to the statistical properties of the DMRS pilot symbols, the statistics of Z₁ are same as those of Z₂. In addition, equations (109) and (110), shows that the first dimension of the output matrix after being applied the port reduction becomes P<Nᵣ.

Types of port reduction in accordance with this disclosure is described herein.

In some embodiments, three types of port reduction may be categorized, such as PMI, MRC, CM (canonical model), common vertical beam.

MRC-based port reduction with one DMRS symbol in accordance with this disclosure is described herein. Since MRC-based port reduction requires channel state information (CSI) at the MMU, SRS channel measurements may be used as given by equation (112):

$${\hat{H}}_{SRS} ( l , k , r ) = H ( l , k , r ) + {Z}_{SRS} ( l , k , r ) , \qquad ( 112 )$$

where H(l, k₁, r) is the true channel response at the kth DMRS pilot subcarrier, lth PUSCH symbol, and rth element of gNB antenna array with an additional noise expressed by N_{SRS}(l, k, r). Due to required CSI for the MRC processing, the decorrelated CFR or LS-estimated CFR may be used, that is, either R_{decor}([3,12]) or R_{decor}(3).

In some embodiments, when only one DMRS symbol is used within one slot, and for the frequency comb-2 configuration, i.e., k₂−k₁=2, and K=Nᵣ/P, a port reduction ratio, a frequency dependent compression weight Cₖ_{₁}, for example for the DMRS pilots located at k₁th subcarrier is given by Equation (113).

$$C ( 3 , {k}_{1} ) = [ \begin{matrix}{\hat{H}}_{SRS , 3 , {k}_{1}}^{* , ( 1 : K )} & & & \\ & {\hat{H}}_{SRS , 3 , {k}_{1}}^{* , ( K + 1 : 2 K )} & & \\ & & ⋱ & \\ & & & {\hat{H}}_{SRS , 3 , {k}_{1}}^{* , ( {N}_{r} - K : {N}_{r} )}\end{matrix} ] \qquad ( 113 )$$

$$[ \begin{matrix}\frac{{I}_{K \times K}}{{\sum }_{i = 1}^{K} \vert {{\hat{H}}_{SRS} ( 3 , {k}_{1} , i ) {\vert}^{2}}^{{}_{}}} & & & \\ & \frac{{I}_{K \times K}}{{\sum }_{i = 1}^{K} \vert {{\hat{H}}_{SRS} ( 3 , {k}_{1} , K +}^{{}_{}} {i ) {\vert}^{2}}^{{}_{}}} & & \\ & & ⋱ & \\ & & & \frac{{I}_{K \times K}}{{\sum }_{i = 1}^{K} \vert {\hat{H}}_{SRS} ( 3 , {k}_{1} , ( P - {1 ) K + i ) {\vert}^{2}}^{{}_{}}}\end{matrix} ] ,$$

$$where$$

$${\hat{H}}_{SRS , 3 , {k}_{1}}^{* , ( K ( j - 1 ) + 1 : jK )} = {[ {\hat{H}}_{SRS} ( 3 , {k}_{1} , K ( j - 1 ) , {\hat{H}}_{SRS} ( 3 , {k}_{1} , K ( j - 1 ) + 2 ) , … , {\hat{H}}_{SRS} ( 3 , {k}_{1} , jK ) ]}^{T} .$$

Thus, at the k₁ th DMRS pilot, its MRC output is given by MRC(k₁)=C(3, k₁)[R_{(decor)}(3, k₁, 1), R_{(decor)}(3, k₁, 2), . . . , R_{(decor)}(3, k₁, Nᵣ)]^{T}, whose first dimensionality is P.

Applying MRC-based port reduction to all DMRS pilots, whose size is M_{SC}, the MRC outputs concatenated into the second axis is given by equation (114):

$${C}_{MRC} = [ MRC ( {k}_{1} ) , MRC ( {k}_{2} ) , … , MRC ( {k}_{MS} ) ] . \qquad ( 114 )$$

Thus, the dimensionality of C_{MRC} is given by P×MS.

When, k₂−k₁=2, i.e., a frequency comb-2 DMRS configuration, the same MRC(k₁) may be used for the missing next subcarrier at k₁+1.

MRC-based port reduction with two DMRS symbols and frequency comb-2 configuration in accordance with this disclosure is described herein.

In some embodiments, since MRC-based port reduction requires channel state information (CSI) at MMU, SRS channel measurements may be used as given by the following equation:

$${\hat{H}}_{SRS} ( l , k , r ) = H ( l , k , r ) + {Z}_{SRS} ( l , k , r ) ,$$

where H(l, k₁, r) is the true channel response at the kth DMRS pilot subcarrier, 1th PUSCH symbol, and rth element of gNB antenna array with an additional noise expressed by Z_{SRS}(l, k, r).

Before applying the MRC-based port reduction, each row vector of R_{decor} (3) and R_{decor} (12) can be concatenated, in such a way that, as provide by equation (115):

$${\tilde{R}}_{decor} ( [ 3 , 12 ] ) = [ \begin{matrix}{R}_{( decor )} ( 3 , {k}_{1} , 1 ) , {R}_{( decor )} ( 3 , {k}_{1} , 2 ) , … , {R}_{( decor )} ( 3 , {k}_{1} , {N}_{r} ) \\ {R}_{( decor )} ( 12 , {k}_{1} , 1 ) , {R}_{( decor )} ( 12 , {k}_{1} , 2 ) , … , {R}_{( decor )} ( 12 , {k}_{1} , {N}_{r} ) \\ {R}_{( decor )} ( 3 , {k}_{2} , 1 ) , {R}_{( decor )} ( 3 , {k}_{2} , 2 ) , … , {R}_{( decor )} ( 3 , {k}_{2} , {N}_{r} ) \\ {R}_{( decor )} ( 12 , {k}_{2} , 1 ) , {R}_{( decor )} ( 12 , {k}_{2} , 2 ) , … , {R}_{( decor )} ( 12 , {k}_{2} , {N}_{r} ) \\ ⋮ \\ {R}_{( decor )} ( 12 , {k}_{{M}_{SC}} , 1 ) , {R}_{( decor )} ( 12 , {k}_{{M}_{SC}} , 2 ) , … , {R}_{( decor )} ( 12 , {k}_{{M}_{SC}} , {N}_{r} )\end{matrix} ] . \qquad ( 115 )$$

Then, for a common C(3, k₁), it can be MRC(k₁)=C(3, k₁)[R_{(decor)}(3, k₁, 1), R_{(decor)}(3, k₁, 2), . . . , R_{(decor)}(3, k₁, Nᵣ)]^{T} and MRC (k₁+1)=C(3, k₁)[R_{(decor)}(12, k₁, 1), R_{(decor)}(12, k₁, 2), . . . , R_{(decor)}(12, k₁, Nr)]^{T}. The MRC outputs concatenated into the second axis is given by equation (116):

$${C}_{{MRC}_{2}} = [ MRC ( {k}_{1} ) , MRC ( {k}_{1} + 1 ) , MRC ( {k}_{2} ) … , MRC ( {k}_{MS} ) , MRC ( {k}_{MS} + 1 ) ] . \qquad ( 116 )$$

Thus, the dimensionality of C_{MRC}_{₂} is given by P×2MS. MRC-based port reduction can be time independent. However, equations (114) and (117) shows that MRC-based port reduction is frequency dependent. In some embodiments that use a frequency independent MRC weight, this may not be optimal such that a performance loss may be expected.

CM-based port reduction with one DMRS symbol in accordance with this disclosure is described herein. In some embodiments, in contrast to the MRC-based port reduction, the CM-based port reduction may be time and frequency independent. That is, a latency between SRS and DMRS and aging of the SRS channel estimate are not a factor that determines the performance of the port reduction.

FIG. 9 illustrates an example of codebook (CB) generation in terms of the configuration of the antenna array in accordance with an embodiment. The CM-based port reduction matrix C_{CM}, can be obtained by projecting R(3) on to the beam steering codebook matrix, where one of its examples for the front antenna array, illustrated in FIG. 6 is given by FIG. 9, where N₁=Nₕ=4, N₂=Nᵥ=2,p=2,dₕ=λ/2, and dᵥ=λ/2. Oversampling with rate=2 may be employed to generate 64 grids, or codebook (CB) elements. The jth CB element is denoted by cbⱼ.

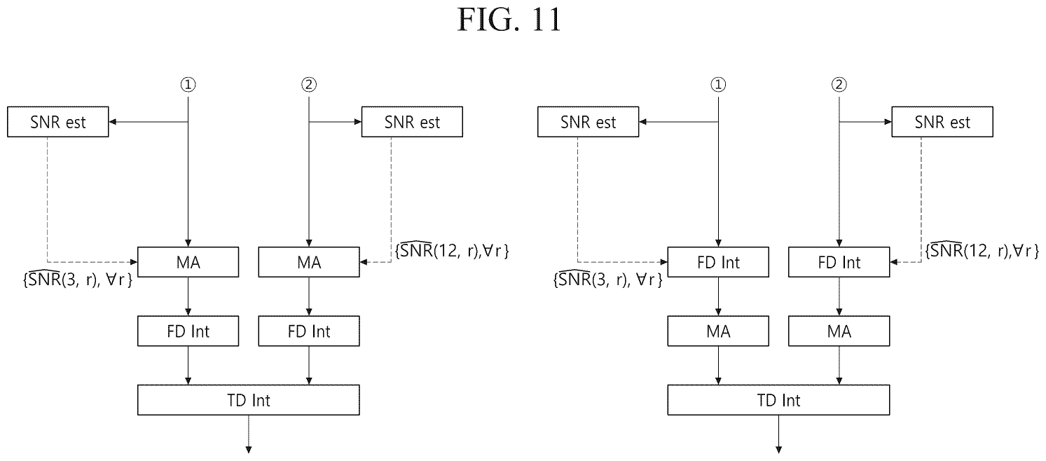

FIG. 10 illustrates sampling angular and selected grids to generate beams (basis) in accordance with an embodiment. Four patterns are provided in this example. Due to the use of oversampling both in the first and second axis, there are four different groups, each of which is illustrated by a different color and pattern illustrated in FIG. 11 in accordance with an embodiment. Referring to the employed antenna array at the fronthead of MMU, R(3) is further expressed as follows by equation (117):

$$R ( 3 ) = [ \begin{matrix}R ( 3 , {k}_{1} , 1 ) & ⋯ & R ( 3 , {k}_{1} , \frac{{N}_{r}}{2} ) & R ( 3 , {k}_{1} , \frac{{N}_{r}}{2} + 1 ) & ⋯ & R ( 3 , {k}_{1} , {N}_{r} ) \\ R ( 3 , {k}_{2} , 1 ) & ⋯ & R ( 3 , {k}_{2} , \frac{{N}_{r}}{2} ) & R ( 3 , {k}_{2} , \frac{{N}_{r}}{2} + 1 ) & ⋯ & R ( 3 , {k}_{2} , {N}_{r} ) \\ ⋮ & ⋯ & ⋮ & ⋮ & ⋯ & ⋮ \\ R ( 3 , {k}_{MS} , 1 ) & ⋯ & R ( 3 , {k}_{MS} , \frac{{N}_{r}}{2} ) & R ( 3 , {k}_{MS} , \frac{{N}_{r}}{2} + 1 ) & ⋯ & R ( 3 , {k}_{MS} , {N}_{r} )\end{matrix} ] = [ \begin{matrix}{R}_{3 , {k}_{1}}^{P 1} & {R}_{3 , {k}_{1}}^{P 2} \\ {R}_{3 , {k}_{2}}^{P 1} & {R}_{3 , {k}_{2}}^{P 2} \\ ⋮ & ⋮ \\ {R}_{3 , {k}_{MS}}^{P 1} & {R}_{3 , {k}_{MS}}^{P 2}\end{matrix} ] , \qquad ( 117 )$$

$$where$$

$${R}_{3 , {k}_{i}}^{{P}_{1}} = [ R ( 3 , {k}_{1} , 1 ) , … , R ( 3 , {k}_{1} , \frac{{N}_{r}}{2} ) ]$$

$$and$$

$${R}_{3 , {k}_{i}}^{{P}_{2}} = [ R ( 3 , {k}_{1} , \frac{{N}_{r}}{2} + 1 ) , … , R ( 3 , {k}_{1} , {N}_{r} ) ]$$

are respectively CFR at the kith DMRS pilots and the ith polarization of Pᵢ. Dimensionality of R_{3,k}_{ᵢ}^{P}^{₁} and R_{3,k}_{ᵢ}^{P}^{₂} is

$$1 \times \frac{{N}_{r}}{2} ,$$

so that the dimensionality of R(3) is MS×Nᵣ.

A procedure of obtaining the port reduction matrix for the CM representation of the raw CFR is given by as:
(i) Compute an average power or instantaneous power of the kᵢth subcarrier w.r.t. each codebook, cbⱼ, that is

$${p}_{ij} = {\vert {( {R}_{3 , {k}_{i}}^{{P}_{1}} )}^{H} {cb}_{j} \vert}^{2} + {\vert {( {R}_{3 , {k}_{i}}^{{P}_{2}} )}^{H} {cb}_{j} \vert}^{2} .$$

(ii) Compute the average value of p_{i,j} with respect to all subcarriers, that is,

$${p}_{j} = \frac{1}{MS} {\sum }_{i} {p}_{i , j} ,$$

for different color and pattern, so that pₚₐₜₜₑᵣₙ₁=Σ_{j∈pettern1}pj. Similarly, compute Pₚₑₜₜₑᵣₙ₂, Pₚₐₜₜₑᵣₙ₃, and Pₚₐₜₜₑᵣₙ₄.
(iii) A beam group that achieves the largest sum power is selected. That is, i*=max arg_{i∈{pattern1,pattern2,pattern3,pattern4}}pᵢ.
(iv) Within a selected group, select

$$\frac{P}{2}$$

indices that results in

$$\frac{P}{2}$$

largest powers, so that this process makes satisfy orthonormality among selected beams.
(v) Form a spatial basis matrix, \tilde{C}B, in terms of selected P/2 codebooks, so that the port reduction matrix is formed as

$${C}_{CM} = [ \begin{matrix}\tilde{CB} & 0 \\ 0 & \tilde{CB}\end{matrix} ] ∈ {C}^{P \times {N}_{r}} ,$$

wherein the same \tilde{C}B is used for both polarizations.

Due to processing stage (ii), the obtained C_{CM} becomes frequency independent, that is, it is working for wideband. Also, SRS-based CSI may not need to be used, so that a latency between SRS and DMRS and aging of the SRS channel estimate can be removed by the CM-based port reduction.

According to equation (105), the raw CFR may be directly decomposed in such a way that the CFR after the CM-based port reduction is given by Equation (118):

$${C}_{CM} \cdot {R ( 3 )}^{H} = {C}_{CM} \cdot {H ( 3 )}^{H} ⊗ {\tilde{P} ( 3 )}^{H} + {C}_{CM} \cdot {Z ( 3 )}^{H} . \qquad ( 118 )$$

That is, the channel estimate can be accomplished after the CM-based port reduction.

CM-based port reduction with two DMRS symbols in accordance with this disclosure is described herein.

In some embodiments, based on equation (106), that is, for R_{[3,12]}=H_{[3,12]}⊗P_{[3,12]}+N_{[3,12]}, the CM-based port reduction can be accomplished by multiplying the port reduction matrix by the concatenated CFR. That is, as provided by Equation (119):

$${C}_{CM} \cdot {R ( [ 3 , 12 ] )}^{H} = {C}_{CM} \cdot {H ( [ 3 , 12 ] )}^{H} ⊗ {\tilde{P} ( [ 3 , 12 ] )}^{H} + {C}_{CM} \cdot {Z ( [ 3 , 12 ] )}^{H} . \qquad ( 119 )$$

Channel estimation after the port reduction in accordance with this disclosure is described herein. FIG. 11 illustrates a main channel estimation flow that processes the outputs of the port reduction illustrated in FIGS. 8A and 8B in accordance with an embodiment. In some embodiments, having applied the CM-based port reduction, Equation (118) can be written as Equation (120):

$${C}_{CM} \cdot {R ( 3 )}^{H} = {C}_{CM} \cdot {H ( 3 )}^{H} ⊗ {\tilde{P} ( 3 )}^{H} + {C}_{CM} \cdot {Z ( 3 )}^{H} , \qquad ( 120 )$$

$$where$$

$${\tilde{R} ( 3 )}^{H} = {\tilde{H} ( 3 )}^{H} ⊗ {\tilde{P} ( 3 )}^{H} + {{\tilde{Z}}_{CM} ( 3 )}^{H} ,$$

$$with$$

$${\tilde{R} ( 3 )}^{H} ≡ {C}_{CM} \cdot {R ( 3 )}^{H} , {\tilde{H} ( 3 )}^{H} ≡ {C}_{CM} \cdot {H ( 3 )}^{H} ,$$

$$and$$

$${{\tilde{Z}}_{CM} ( 3 )}^{H} ≡ {C}_{CM} \cdot {Z ( 3 )}^{H} .$$

As illustrated in FIG. 11, in some embodiments, a channel estimation is composed of i) LS-based coarse channel estimation, ii) SNR estimation, iii) Moving average (MA)-based noise reduction, iv) Frequency domain interpolation (FD Int), and V) Time domain interpolation (TD Int).

LS-based coarse channel estimation in accordance with this disclosure is described herein. In some embodiments, from Equation (120), the LS-based coarse CFR estimate for P antenna ports and MS DMRS pilots can be obtained as \tilde{R}(3)^{H}∈C^{P×MS} after applying the element-wise division by \tilde{P}(3)^{H}. Similarly, for the outputs of the CM-based port reduction with two DMRS symbols, the LS-based CFR estimates can be obtained as \tilde{R}([3,12])^{H} for P antenna ports and two MS DMRS pilot. Since LS does not require CFR statistical information, its operation may be simple. However, its performance may be easily impacted by noise.

SNR estimation based on the port-reduced channel estimate in accordance with this disclosure is described herein. \tilde{R}(3) may be used as one exemplary. Note that its dimensionality is MS×P, that is, the second dimension is reduced from Nᵣ to P.

For a particular antenna port, r, the SNR is estimated using multiple subcarriers' CFR. Let ŜNR(3, r) be the SNR estimate for first DMRS symbol located at l=3 and the rth antenna. When the second DMRS symbol, located at l=12, is available, the SNR estimate at antenna r, is also computed as ŜNR(12, r).

Moving average-based noise reduction in accordance with this disclosure is described herein. In some embodiments, although LS-based coarse CFR estimation is made for the outputs of the port reduction, its performance may not be good particularly in the low SNR region due to the existence of the noise, expressed by C_{CM} Z (3) in Equation (120). Since the CFR statistics after the port reduction may be hard to obtain a priori in the real system, a moving average (MA)-based noise reduction may be used. The MA recognizes the CFR estimate as a deterministic unknown value.

At low SNRs, a bigger MA window may be required to mitigate the noise effect. However, as the SNR increases, MA will be a dominating error source rather than reducing the noise, so that this may cause an error floor in the high SNR region. From this reason, it may be necessary to determine MA window size depending on the value of ŜNR(3, r). In general, as the value of ŜNR(3, r) increases, MA window size decreases. Let W_{MA}(3, r) be an odd-numbered MA window size of the DMRS located at l=3 and rth antenna. For a particular element of CFR estimate \hat{R}(3)=[ . . . \hat{R}(3, k, r) . . . ], an antenna dependent \hat{R}(3, k, r) is updated (enhanced) as follows by averaging all \hat{R}s within a window bounded by k−W_{MA}(3, r)/2≤k′≤k+W_{MA}(3, r)/2: as provided by Equation (121):

R̅(3,k,r)=1/W_{MA}(3,r)Σ_{k′=k-W}_{_{MA}}_{(3,r)/2}^{k′=k+W}^{_{MA}}^{(3,r)/2}\tilde{R}(3,k′r). (121)

When the second DMRS is available, for example, at l=12, then the noise reduced CFR estimate is given by Equation (122):

$$\overline{R} ( 12 , k , r ) = \frac{1}{{W}_{MA} ( 12 , r )} {\sum }_{{k}^{′} = k - {W}_{MA} ( 12 , r ) / 2}^{{k}^{′} = k + {W}_{MA} ( 12 , r ) / 2} \hat{\tilde{R}} ( 12 , {k}^{′} , r ) , \qquad ( 122 )$$

where W_{MA}(12, r) is the MA window size determined by the SNR estimate.

FD interpolation in accordance with this disclosure is described herein. In some embodiments, having reduced noise in the CFR estimate, it is ready to use the frequency domain interpolation to estimate the missing estimate from the CFR estimation grid. In some embodiments, for a particular DMRS type and configuration, a frequency comb-2 may be assumed to be chosen for the PUSCH frame structure. Then, Equations (121) and (122) should be re-expressed as Equation (123):

$$\overline{R} ( 3 , {k}_{i} , r ) = \frac{1}{{W}_{MA} ( 3 , r )} {\sum }_{{k}^{′} = {k}_{i} - {W}_{MA} ( 3 , r ) / 2}^{{k}^{′} = {k}_{i} + {W}_{MA} ( 3 , r ) / 2} \hat{\tilde{R}} ( 3 , {k}^{′} , r ) , \qquad ( 123 )$$

where kᵢ₊₁−kᵢ=2. Thus, a missing CFR estimate \hat{R}(3, kᵢ+1, r) needs to be estimated from its neighboring estimates, such as {R̅(3, k_{i-d}, r), R̅(3, k_{i-d+1}, r), . . . , \hat{R}(3, kᵢ, r), R̅(3, Kᵢ₊₁, r) . . . , R̅(3, k_{i+d-1}, r), R̅(3, k_{i+d}, r)}. In some embodiments, either a linear interpolation, a cubic spline, or a wiener interpolation may be used to estimate R̅(3,kᵢ+1, r) from a set of estimates {R̅(3, k_{i-d}, r), R̅(3, k_{i-d+1}, r), . . . , R̅(3, kᵢ, r), R̅(3, kᵢ₊₁, r) . . . , R̅(3, k_{i+d-1}, r), R̅(3, k_{i+d}, r)} Since FD can propagate CFR estimation errors in the frequency domain, a good quality CFR estimate is necessary.

TD interpolation in accordance with this disclosure is described herein. In general, a slot of the frame structure of PUSCH may include a fixed number of DMRS symbols. Thus, a same number of CFR estimates of a whole band for DMRS is available. To make CFR estimate for missing grids in the time domain, it may be necessary to apply the time domain interpolation. In some embodiments, for two available DMRSs at l={3,12}, that is, {R̅(3, k, r), ∀k, r} and {R̅(12, k, r), ∀k, r}, remaining {R̅(I, k, r), ∀k, r} for l=1, . . . , N, l≠{3,12}, can be estimated by applying interpolation and extrapolation. Since FD can propagate CFR estimation errors in the time domain, a good quality CFR estimate may be necessary.

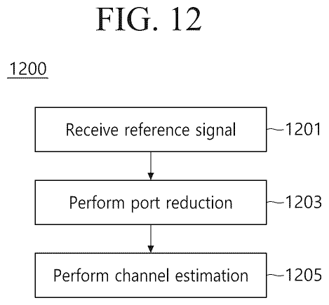

FIG. 12 illustrates a flow chart of an example process for a BA session transfer by an AP in accordance with an embodiment. Although one or more operations are described or shown in particular sequential order, in other embodiments the operations may be rearranged in a different order, which may include performance of multiple operations in at least partially overlapping time periods. The flowchart depicted in FIG. 12 illustrates operations performed in a gNB, such as the gNB illustrated in FIG. 1.

The process 1200, in operation 1201, the gNB receives a reference signal. In some embodiments, the receiver receives a demodulation reference signal (RMRS) that includes channel frequency response (CRR).

In operation 1203, the gNB performs port reduction to the CFR inputs. In some embodiments, the receiver performs a CM-based port reduction. In certain embodiments, the gNB performs an MRC-based port reduction.

In operation 1205, the gNB performs channel estimation to the received CFR with the reduced dimension in the antenna domain. In some embodiments, one or more LS estimators apply the channel estimation in the reduced dimension in the antenna domain.

Embodiments in accordance with this disclosure may apply port reduction to two CFR inputs and a channel estimate is applied to the received CFR with the reduced dimension in the antenna domain, in particular, the channel estimator uses the outputs from a port reduction block whose antenna dimension is reduced by the port reduction algorithm, which can reduce computation complexity such that channel estimation and equalization operate on smaller data dimension compared to a receiver antenna number.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A base station (BS) in a wireless communication system, comprising:
a memory; and
a processor coupled to the memory, the processor configured to:
receive a demodulation reference signal (DMRS) symbol that includes channel frequency response information;
perform port reduction to the channel frequency response information so as to reduce a dimension in an antenna domain for the channel frequency response information; and
perform channel estimation on the channel frequency response information with the reduced dimension in the antenna domain.

2. The BS of claim 1, wherein the port reduction is performed to the channel frequency response information based on a total number of antenna ports and a target number of antenna ports in the antenna domain, the target number of antenna ports being smaller than the total number of antenna ports.

3. The BS of claim 1, wherein the channel frequency response information is associated with at least one of a particular DMRS subcarrier, a particular physical uplink channel symbol, or a particular element of an antenna array.

4. The BS of claim 1, wherein the channel frequency response information is associated with the DMRS symbol and a channel response of the DMRS symbol.

5. The BS of claim 1, wherein:
the port reduction is performed using a maximum ratio combining for the DMRS symbol; and
the processor is configured to compute a channel response at a particular DMRS subcarrier, a particular physical uplink channel symbol, and a particular element of an antenna array.

6. The BS of claim 1, wherein the port reduction is performed using a maximum ratio combining for a plurality of DMRS symbols that are time independent and frequency dependent.

7. The BS of claim 1, wherein the port reduction is performed using a canonical model for one DMRS symbol that includes a canonical-based port reduction matrix, the canonical-based port reduction matrix being obtained based on the channel frequency response information.

8. The BS of claim 1, wherein the port reduction is performed using a canonical model for a plurality of DMRS symbols, wherein the channel frequency information is based on a port reduction matrix and a DMRS subcarrier.

9. The BS of claim 1, wherein the channel estimation is performed using a least-squares based channel estimation based on a reduced number of ports.

10. The BS of claim 1, wherein the processor is further configured to:
perform frequency domain interpolation to the estimated channel to generate revised channel estimates; and
perform time domain interpolation to the revised channel estimates.

11. A computer-implemented method for wireless communication by a base station (BS), comprising:
receiving a demodulation reference signal (DMRS) symbol that includes channel frequency response information;
performing port reduction to the channel frequency response information so as to reduce a dimension in an antenna domain for the channel frequency response information; and
performing channel estimation on the channel frequency response information with the reduced dimension in the antenna domain.

12. The computer-implemented method of claim 11, wherein the port reduction is performed to the channel frequency response information based on a total number of antenna ports and a target number of antenna ports in the antenna domain, the target number of antenna ports being smaller than the total number of antenna ports.

13. The computer-implemented method of claim 11, wherein the channel frequency response information is associated with at least one of a particular DMRS subcarrier, a particular physical uplink channel symbol, or a particular element of an antenna array.

14. The computer-implemented method of claim 11, wherein the channel frequency response information is associated with the DMRS symbol and a channel response of the DMRS symbol.

15. The computer-implemented method of claim 11, wherein:
the port reduction is performed using a maximum ratio combining for the DMRS symbol; and
wherein the method further comprises computing a channel response at a particular DMRS subcarrier, a particular physical uplink channel symbol, and a particular element of an antenna array.

16. The computer-implemented method of claim 11, wherein the port reduction is performed using a maximum ratio combining for a plurality of DMRS symbols that are time independent and frequency dependent.

17. The computer-implemented method of claim 11, wherein the port reduction is performed using a canonical model for one DMRS symbol that includes a canonical-based port reduction matrix, the canonical-based port reduction matrix being obtained based on the channel frequency response information.

18. The computer-implemented method of claim 11, wherein the port reduction is performed using a canonical model for a plurality of DMRS symbols, wherein the channel frequency information is based on a port reduction matrix and a DMRS subcarrier.

19. The computer-implemented method of claim 11, wherein the channel estimation is performed using a least-squares based channel estimation based on a reduced number of ports.

20. The computer-implemented method of claim 11, further comprising:
performing frequency domain interpolation to the estimated channel to generate revised channel estimates; and
performing time domain interpolation to the revised channel estimates.
